(19) United States
(12) Patent Application Publication
(10) Pub. No.: US 2012/0274206 A1
(43) Pub. Date: Nov. 1, 2012

(54) PLASMA DISPLAY PANEL

(76) Inventors: Kaname Mizokami, Kyoto (JP); Koyo Sakamoto, Osaka (JP)

(21) Appl. No.: 13/520,132

(22) PCT Filed: Oct. 27, 2011
(86) PCT No.: PCT/JP2011/006013

§ 371 Date: Jun. 29, 2012

(30) Foreign Application Priority Data
Nov. 5, 2010 (JP) 2010-248074

(51) Int. Cl. H01J 17/49

(52) U.S. Cl. 313/587

(57) ABSTRACT

A plasma display panel is provided with a front plate and a rear plate disposed to oppose the front plate. The front plate includes a display electrode, a dielectric layer covering the display electrode, and a protective layer covering the dielectric layer. The protective layer includes a base layer and a metal oxide formed on the base layer. The metal oxide is resulted from grinding a metal oxide coarse particle. The metal oxide and the metal oxide coarse particle have peaks of photoluminescence in a wavelength range between 200 nm and 300 nm. The peak of the metal oxide has an intensity that is 60% or more and less than 100% of that of the peak of the metal oxide coarse particle.

### TECHNICAL FIELD

The technology disclosed herein relates to a plasma display panel to be used in a display device.

### BACKGROUND ART

One of the functions of a protective layer of a plasma display panel (hereinafter, referred to as “PDP”) is to release initial electrons for causing address discharge. In order to reduce erroneous address discharge, a technique for providing magnesium oxide crystal particles in the protective layer is known (see, for example, Patent Literature 1).

### Citation List

### Patent Literature

### Patent Literature 1: Unexamined Japanese Patent Publication No. 2006-134735

### SUMMARY OF THE INVENTION

A PDP is provided with a front plate and a rear plate disposed to oppose the front plate. The front plate includes a display electrode, a dielectric layer covering the display electrode, and a protective layer covering the dielectric layer. The protective layer includes a base layer and a metal oxide formed on the base layer. The metal oxide is resulted from grinding a metal oxide coarse particle. The metal oxide and the metal oxide coarse particle have peaks of photoluminescence in a wavelength range between 200 nm and 300 nm. The peak of the metal oxide has an intensity that is 60% or more and less than 100% of that of the peak of the metal oxide coarse particle.

### BRIEF DESCRIPTION OF DRAWINGS

FIG. 1 is a perspective view of a structure of a PDP according to an exemplary embodiment.

FIG. 2 is a schematic diagram illustrating a cross section of a front plate according to the exemplary embodiment.

FIG. 3 is a schematic diagram illustrating magnesium oxide coarse particles before grinding according to the exemplary embodiment.

FIG. 4 is a schematic diagram illustrating the magnesium oxide coarse particles after the grinding according to the exemplary embodiment.

FIG. 5 is a flowchart depicting a method of forming a protective layer according to the embodiment.

FIG. 6 is a diagram illustrating a photoluminescence waveform.

FIG. 7 is a diagram illustrating a drive waveform to be applied to the PDP.

FIG. 8 is a diagram depicting an evaluation result of the PDP.

### DESCRIPTION OF EMBODIMENT

[1. Structure of PDP 1]

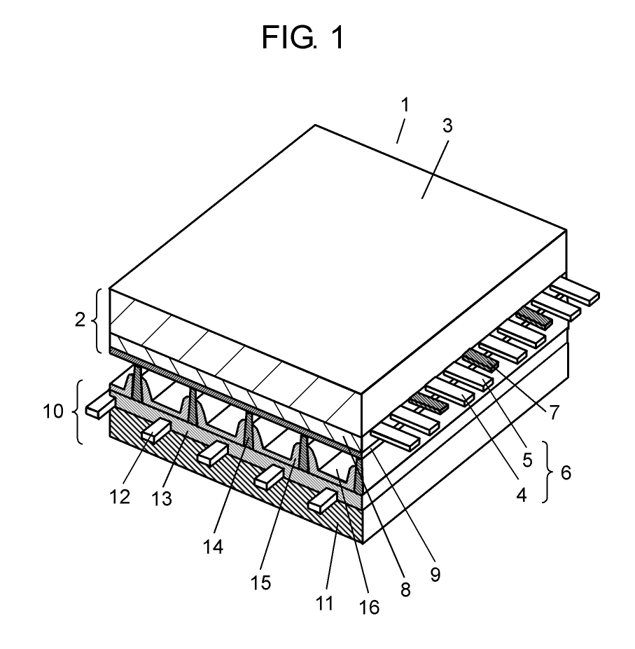

PDP 1 according to this embodiment is an AC surface discharge type PDP. As illustrated in FIG. 1, PDP 1 has a structure in which front plate 2 and rear plate 10 are arranged to oppose each other. Outer peripheral portions of front plate 2 and rear plate 10 are hermetically sealed. Discharge space 16 inside PDP 1 thus sealed is filled with a discharge gas containing neon (Ne), xenon (Xe), and the like at a pressure of 55 kPa to 80 kPa.

As an example, a plurality of pairs of belt-like display electrodes 6, each of which is formed of scan electrode 4 and sustain electrode 5, are arranged in a plurality of columns on front glass substrate 3 included in front plate 2. Black stripes 7 are arranged in a plurality of columns. Dielectric layer 8 that works as a capacitor is formed on front glass substrate 3 in a manner to cover display electrodes 6 and black stripes 7. Further, protective layer 9 made of a magnesium oxide (MgO) or the like is formed on a surface of dielectric layer 8.

Here, a transparent electrode may be formed between front glass substrate 3, and scan electrode 4 and sustain electrode 5.

A plurality of belt-like address electrodes 12 are arranged in parallel to one another in a direction perpendicular to display electrodes 6 on rear glass substrate 11 that is included in rear plate 10. Base dielectric layer 13 is formed in a manner to cover address electrodes 12. Further, barrier ribs 14 having a predetermined height and individually partitioning discharge spaces 16 are formed on base dielectric layer 13. Phosphor layers 15 that emit light of red, blue, or green by the action of ultraviolet light are formed individually between barrier ribs 14.

Discharge cells are formed in a position where display electrodes 6 and address electrodes 12 intersect with each other. Accordingly, pixels that display colors are formed of a discharge cell emitting red light, a discharge cell emitting blue light, and a discharge cell emitting green light.

[2. Manufacturing Method of PDP 1]

[2-1. Manufacturing Method of Front Plate 2]

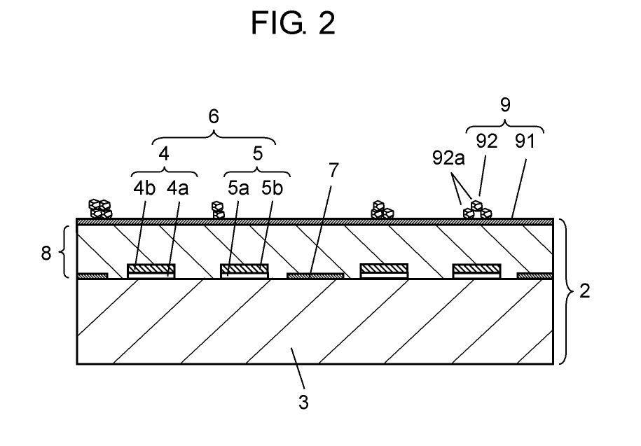

Scan electrode 4, sustain electrode 5, and black stripe 7 are formed by the photolithography method on front glass substrate 3. As illustrated in FIG. 2, scan electrode 4 and sustain electrode 5 include white electrodes 4b and 5b, respectively, containing therein silver (Ag) for providing conductivity. In addition, scan electrode 4 and sustain electrode 5 include black electrodes 4a and 5a, respectively, containing therein black pigments for improving contrast of an image display screen. White electrode 4b is stacked on top of black electrode 4a. White electrode 5b is stacked on top of black electrode 5a.

Black paste containing black pigments for securing blackness, glass frit for binding the black pigments, a photosensitive resin, a solvent, and the like is used as a material for black electrodes 4a and 5a. First, the black paste is coated on front glass substrate 3 by the screen printing or the like. Next, the solvent in the black paste is removed in a baking oven. Then, the black paste is subjected to exposure through a photomask having a predetermined pattern.

White paste containing silver (Ag), glass frit for binding silver, a photosensitive resin, a solvent, and the like is used as a material for white electrodes 4b and 5b. First, the white paste is coated, by the screen printing or the like, on front glass substrate 3 on which the black paste has been formed. Next, the solvent in the white paste is removed in a baking oven. Then, the white paste is subjected to exposure through a photomask having a predetermined pattern.

Next, the black paste and the white paste are subjected to development, and thereby a black electrode pattern and a white electrode pattern are formed. Finally, the black electrode pattern and the white electrode pattern are fired in a baking oven at a predetermined temperature. This means that the photosensitive resin in the black electrode pattern and the photosensitive resin in the white electrode pattern are removed. At the same time, the glass frit contained in the black electrode pattern is melted and re-coagulated. The glass frit contained in the white electrode pattern is also melted and re-coagulated. Through the above-mentioned process, black electrodes 4a and 5a, and white electrodes 4b and 5b are formed.

Black stripe 7 is formed in a manner similar to that of black electrodes 4a and 5a. Here, black stripe 7 may be formed simultaneously with black electrodes 4a and 5a. In the above-mentioned process, the sputtering method, the vapor deposition method, or the like can be used other than the method in which the black electrode paste and the white electrode paste are subjected to the screen printing.

Next, dielectric layer 8 is formed. A dielectric paste containing dielectric glass frit, a resin, a solvent, and the like is used as a material for dielectric layer 8. First, the dielectric paste is coated by the die coating method with a predetermined thickness on front glass substrate 3 in a manner to cover scan electrode 4, sustain electrode 5, and black stripe 7.

Next, the solvent in the dielectric paste is removed in a baking oven. Finally, the dielectric paste is fired in a baking oven at a predetermined temperature. This means that the resin in the dielectric paste is removed. At the same time, the dielectric glass frit is melted and re-coagulated. Through the above-mentioned process, dielectric layer 8 is formed. In the above-mentioned process, the screen printing, the spin coating process, or the like can be used other than the method in which the dielectric paste is subjected to the die coating. Further, it is also possible to form a film that serves as dielectric layer 8 by the CVD (Chemical Vapor Deposition) method or the like without using the dielectric paste.

Next, protective layer 9 is formed on dielectric layer 8. The details of protective layer 9 will be described later.

Through the above-mentioned process, front plate 2 including predetermined structural members is completed on front glass substrate 3. To state it differently, front plate 2 is completed by forming scan electrode 4, sustain electrode 5, black stripe 7, dielectric layer 8, and protective layer 9 on front glass substrate 3.

[2-2. Manufacturing Method of Rear Plate 10]

Address electrode 12 is formed on rear glass substrate 11 by the photolithography method. An address electrode paste containing silver (Ag) for providing conductivity, glass frit for binding silver, a photosensitive resin, a solvent, and the like is used as a material for the address electrode. First, an address electrode paste is coated by the screen printing or the like with a predetermined thickness on rear glass substrate 11. Next, the solvent in the address electrode paste is removed in a baking oven. Then, the address electrode paste is subjected to exposure through a photomask having a predetermined pattern. Subsequently, the address electrode paste is subjected to development to thereby form an address electrode pattern. Finally, the address paste pattern is fired in a baking oven at a predetermined temperature. This means that the photosensitive resin in the address electrode pattern is removed. At the same time, the glass frit in the address electrode pattern is melted and re-coagulated. Through the above-mentioned process, address electrode 12 is formed. In the above-mentioned process, the sputtering method, the vapor deposition method, or the like can be used other than the method in which the address electrode paste is subjected to the screen printing.

Next, base dielectric layer 13 is formed. A base dielectric paste containing base dielectric glass frit, a resin, a solvent, and the like is used as a material for base dielectric layer 13. First, base dielectric paste is coated by the screen printing or the like with a predetermined thickness on rear glass substrate 11 on which address electrode 12 is formed in a manner to cover address electrode 12. Next, the solvent in the base dielectric paste is removed in a baking oven. Finally, the base dielectric paste is fired in a baking oven at a predetermined temperature. This means that the resin in the base dielectric paste is removed. Further, the base dielectric glass frit is melted and re-coagulated. Through the above-mentioned process, base dielectric layer 13 is formed. In the above-mentioned process, the die coating method, the spin coating method, or the like can be used other than a method in which the base dielectric paste is subjected to the screen printing. Further, it is also possible to form a film that serves as base dielectric layer 13 by the CVD (Chemical Vapor Deposition) method or the like without using the base dielectric paste.

Next, barrier rib 14 is formed by the photolithography method. A barrier rib paste containing a filler, glass frit for binding the filler, a photosensitive resin, a solvent, and the like is used as a material for barrier rib 14. First, a barrier rib paste is coated by the die coating method or the like with a predetermined thickness on base dielectric layer 13. Next, the solvent in the barrier rib paste is removed in a baking oven. Then, the barrier rib paste is subjected to exposure through a photomask having a predetermined pattern. Subsequently, the barrier rib paste is developed to form a barrier rib pattern. Finally, the barrier rib pattern is fired in a baking oven at a predetermined temperature. This means that the photosensitive resin in the barrier rib pattern is removed. At the same time, the glass frit in the barrier rib pattern is melted and re-coagulated. Through the above-mentioned process, barrier rib 14 is formed. In the above-mentioned process, it is also possible to use the sandblasting method other than the photolithography method.

Next, phosphor layer 15 is formed. A phosphor paste containing phosphor particles, a binder, a solvent, and the like is used as a material for phosphor layer 15. First, the phosphor paste is coated by dispensing method with a predetermined thickness on base dielectric layer 13 and a side face of barrier rib 14 between barrier ribs 14 that are adjacent to each other. Next, the solvent in the phosphor paste is removed in a baking oven. Finally, the phosphor paste is fired in a baking oven at a predetermined temperature. This means that the resin in the phosphor paste is removed. Through the above-mentioned process, phosphor layer 15 is formed. In the above-mentioned process, it is also possible to use the screen printing other than the dispensing method.

Through the above-mentioned process, rear plate 10 including predetermined structural members is completed on rear glass substrate 11. To state it differently, rear plate 10 is completed by forming address electrodes 12, base dielectric layer 13, barrier ribs 14, and phosphor layers 15 on rear glass substrate 11.

[2-3. Assembling Method of Front Plate 2 and Rear Plate 10]

First, a sealing portion (not illustrated) is formed along a periphery of rear plate 10 by the dispensing method or the like. A sealing paste containing grass fit, a binder, and a solvent is used as a material for the sealing portion (not illustrated). Next, the solvent in the sealing paste is removed in a baking oven. Then, front plate 2 and rear plate 10 are arranged to oppose each other so that display electrode 6 and address electrode 12 intersect at right angles with each other. Subsequently, the peripheries of front plate 2 and rear plate 10 are sealed by the glass frit. Finally, discharge space 16 is filled with a discharge gas containing neon (Ne), xenon (Xe), or the like so that PDP 1 is completed.

[3. Details of Protective Layer 9]

As illustrated in FIG. 2, protective layer 9 includes base film 91 and metal oxide crystal particles 92a. As one example, base film 91 is a magnesium oxide (MgO) film containing aluminum (Al) as impurities. In this embodiment, aggregated particles 92 each formed by aggregating a plurality of metal oxide crystal particles 92a are adhered to base film 91 in a manner to be uniformly distributed over the entire surface thereof.

In this embodiment, it serves if a plurality of aggregated particles 92 are adhered to an entire region corresponding to a display region of base film 91. In other words, it is not necessary to adhere aggregated particles 92 to the outside of a region corresponding to the display region of base film 91. Further, the term “uniformly” means that at least one aggregated particle 92 is adhered to each discharge cell. In addition, the plurality of aggregated particles 92 include such a particle in which two to four metal oxide crystal particles 92a are aggregated together.

[3-1. Details of aggregated particle 92]

When the address discharge starts, initial electrons serving as a trigger are released into discharge space 16 from a surface of protective layer 9. Shortage in an amount of the initial electrons are considered as a main reason for a delay in discharge. Aggregated particles 92 and metal oxide crystal particles 92a have an effect of suppressing the delay in discharge mainly in the address discharge and an effect of improving temperature dependency of the delay in discharge. Specifically, aggregated particles 92 and metal oxide crystal particles 92a have high initial electron emission performance. Accordingly, in this exemplary embodiment, aggregated particles 92 and metal oxide crystal particles 92a are provided to serve as a initial electron supply portion that is required when the discharge pulse rises. Aggregated particles 92 and metal oxide crystal particles 92a make abundant initial electrons available in discharge space 16 during the rise of the discharge pulse. As a result, display by PDP 1 becomes further high-definition, the allocation time for the address discharge becomes shorter, the delay in discharge is suppressed, and high-speed operation is made possible.

Aggregated particles 92 is not resulted from the plurality of metal oxide crystal particles 92a being bound as a solid body by a strong binding force. Aggregated particles 92 take a form in which a plurality of primary particles are aggregated together by electrostatic forces or van der Wags forces. Further, aggregated particles 92 are bound together by a degree of an external force such as ultrasonic waves by which part or whole thereof is disintegrated into a state of the primary particles. Preferably, metal oxide crystal particles 92a have a polyhedral shape that has seven or more faces such as dodecahedron or quadridecahedron.

[3-2. Manufacturing Method of Magnesium Oxide Crystal Particles 96]

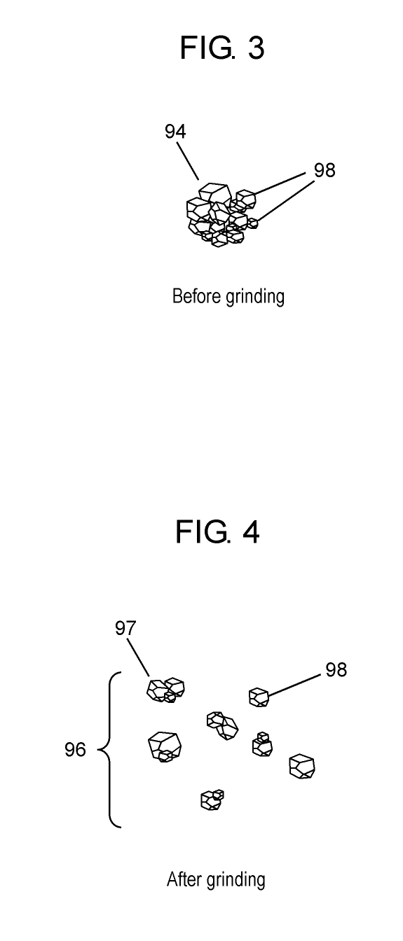

The method according to this embodiment is based on a thermal decomposition method. Specifically, a magnesium oxide precursor (hereinafter, referred to as “precursor”) including a hydroxyl group or a carbonated group is fired in a baking oven or the like. The hydroxyl group or the carbonated group included in the precursor is removed by heat. As a result of this, as illustrated in FIG. 3, magnesium oxide coarse particles 94 which are metal oxide coarse particles are produced. Magnesium oxide coarse particle 94 is a form of aggregation of a plurality of primary particles 98 of magnesium oxide crystals which are metal oxide crystals.

Next, magnesium oxide coarse particles 94 are ground by a ball mill or the like. As illustrated in FIG. 4, magnesium oxide crystal particles 96 having a mean particle size smaller than that of magnesium oxide coarse particles 94 are produced by grinding. Magnesium oxide crystal particles 96 contain magnesium oxide aggregated particles 97 which are resulted from aggregation of primary particles 98 of the magnesium oxide crystal and primary particles 98 of a plurality of magnesium oxide crystals. The particle size of magnesium oxide aggregated particles 97 is smaller than that of magnesium oxide coarse particles 94.

The precursor is produced by the liquid-phase method. Accordingly, the precursor itself is a form of aggregation of the primary particles. There is no specific limitation to the precursor. For example, magnesium hydroxide, basic magnesium carbonate, magnesium carbonate, magnesium oxalate, or the like can be used.

If the precursor contains a lot of impurities, it is possible that unintended impurities are mixed in magnesium oxide crystal particles 96 to be produced. When the impurities are mixed, the characteristic of magnesium oxide crystal particles 96 may vary. Therefore, it is preferable that the amount of the impurities in the precursor be as small as possible. Specifically, as an amount of the impurities contained in the precursor, a total amount of the residual impurities when magnesium oxide crystal particles 96 are produced by the thermal decomposition method is preferably 0.1 weight % or less, and is further preferably 0.01 weight % or less.

An air atmosphere furnace or the like is used as the baking oven. The firing temperature is in a range between 700° C. and 1500° C. The most preferable temperature is 1200° C. The firing period is about 1 hour to 10 hours depending on the firing period. For example, when the firing temperature is about 1200° C., the firing period of about five hours is appropriate. The rate of temperature rise of the baking oven is not particularly restricted. As an example, the rate of temperature rise between 5° C./min and 10° C./min is preferable. The atmosphere during burning is not particularly limited. As an example, air, oxygen, nitrogen, argon, or the like is used. Here, using an oxidizing atmosphere makes it possible to remove the impurities included in the precursor as oxidation gas. This means that air or oxygen is preferable as an atmosphere during firing.

Magnesium oxide coarse particles 94 are produced through the above-mentioned process. The mean particle size of magnesium oxide coarse particles 94 ranges from 1.0 μm to 4.0 μm. In this exemplary embodiment, the mean particle size refers to an accumulated volume mean particle size (D50). Laser light diffraction particle size distribution analyzer MT-3300 (made by Nikkiso Co., Ltd.) is used for measurement of the mean particle size.

If magnesium oxide coarse particles 94 are used as they are for protective layer 9, a problem may be caused in manufacturing equipment. For example, in the case where magnesium oxide coarse particles 94 are adhered by the screen printing, a screen printing plate may be broken. Further, if magnesium oxide coarse particles 94 are used as they are for protective layer 9 when front plate 2 and rear plate 10 are assembled together, barrier rib 14 may be destroyed. Therefore, it is preferable that magnesium oxide coarse particles 94 be ground so that the mean particle size thereof becomes smaller.

In this embodiment, grinding is to crumble the metal oxide coarse particles in which the primary particles aggregate together into metal oxides having a predetermined mean particle size. This means that the metal oxide in which a smaller number of primary particles aggregate together as compared with the same before grinding is produced. In other words, the primary particles of metal oxides are produced by grinding. Accordingly, in this embodiment, the mean particle size of the metal oxide to be produced by grinding may vary from a size of the primary particle of the metal oxide crystal to a size in which a plurality of primary particles of the metal oxide crystals are aggregated together. Here, the particle size of the primary particles of the metal oxide crystals hardly changes by grinding.

However, the grinding causes a problem of reducing the initial electron emission performance of the metal oxide.

In this embodiment, magnesium oxide coarse particles 94 are ground by, for example, a ball mill. Ethanol is used as a solvent during the grinding. Other than ethanol, it is also possible to use an organic solvent such as alcohol, for example, methanol, butanol, or propanol; or glycol, for example, propylene glycol, polypropylene glycol, or ethylene glycol. An amount of the solvent to be used is 20 parts by mass to 1000 parts by mass relative to 100 parts by mass of a raw material to be ground, and preferably 30 parts by mass to 300 parts by mass.

Further, a dispersant may be added to the solvent. The dispersant may be chosen according to the solvent. For example, used as the dispersant is: polymer such as acrylic polymer or amine series polymer; inorganic acid such as nitric acid, hydrochloric acid, or sulfuric acid; organic acid such as oxalic acid, citric acid, acetic acid, malic acid, or lactic acid;

alcohol such as methanol, ethanol, or propanol; surfactant such as polycarboxylic ammonium; or the like. When the dispersant is used, an amount of the dispersant to be added is 0.1 parts by mass to 20 parts by mass relative to 100 parts by mass of the solvent, and preferably 0.2 parts by mass to 10 parts by mass.

In this embodiment, magnesium oxide coarse particles 94 are ground under various conditions. TABLE 1 shows a list of grinding conditions and relative peak intensities of photoluminescence under the individual grinding conditions.

[Table 1]

A ball mill including a pod made of stainless steel is used for the grinding. A diameter of the pod is 24 cm. A volume of the pod is 8 litters.

A diameter of a medium (ball) is 15 mm. A nylon ball with an iron core therein is used as the medium. When zirconium oxide (ZrO₂) or aluminum oxide (Al₂O₃) is used as the medium, it is ground down by magnesium oxide coarse particles 94. This is not preferable because these substances will be mixed with magnesium oxide crystal particles 96 as unexpected impurities.

The filling rate of the medium with respect to the pod is 5 volume percent to 30 volume percent. The filling rate of magnesium oxide coarse particles which are the raw material is 40 volume percent to 75 volume percent. The pod is rotated at a speed of 30 rpm for 2 hours to 10 hours.

Next, the raw material after grinding is ejected from the pod. As a result, magnesium oxide crystal particles 96 have the mean particle size in a range between 0.3 μm and 2 μm. This means that the mean particle size of magnesium oxide crystal particles 96 represents the size in a state including primary particles 98 of magnesium oxide crystals and magnesium oxide aggregated particles 97.

[3-3. Evaluation of Magnesium Oxide Crystal Particles 96]

As indicated in TABLE 1, photoluminescence light-emitting intensities of magnesium oxide coarse particles 94 and magnesium oxide crystal particles 96 are measured. As a comparative example, a photoluminescence light-emitting intensity of magnesium oxide crystal particles 96 ground by a jet mill is also measured. The measurement of the photoluminescence is performed under the following condition. Specifically, an excimer lamp (made by Ushio Inc.) having a light-emitting wavelength of 146 nm is used. The excimer lamp is installed at a position 100 mm above the sample. A pressure in a vacuum chamber is maintained at 1×10⁻² Pa by a turbo molecular pump. A CCD integrated-type spectroscope (made by Hamamatsu Photonics K.K.) covering a wavelength range between 200 nm and 800 nm is used for a detector. Since the wavelength of the incident light is 146 nm, it is considered that the photoluminescence is caused almost on the outermost surface of the sample.

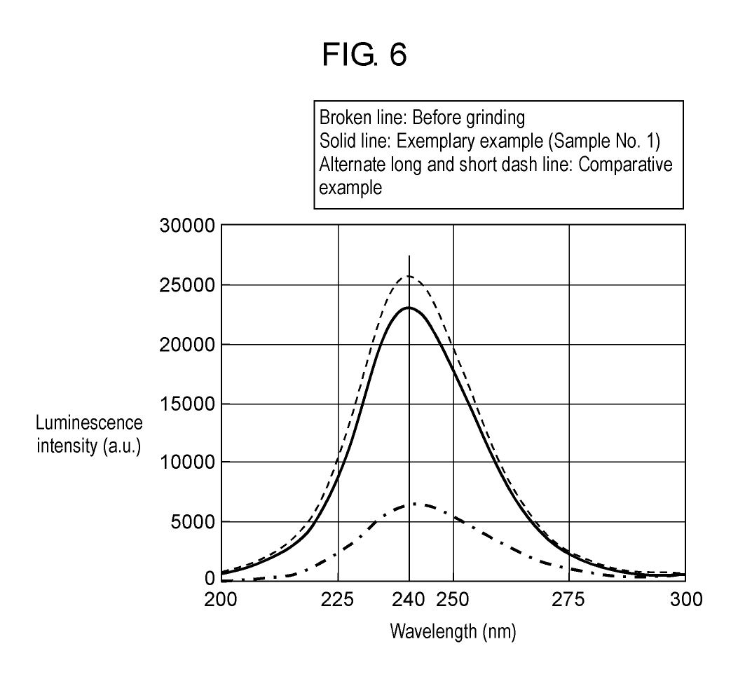

All samples have their luminescence peaks in a wavelength range between 200 nm and 300 nm. FIG. 6 exemplifies photoluminescence waveforms of magnesium oxide coarse particles 94 before grinding, the embodiment example (Sample No. 1), and the comparative example. Although this is not illustrated, each sample has the luminescence peak near a wavelength of 240 nm. The intensity of the luminescence peak of each sample as indicated in TABLE 1 represents a relative value (relative peak intensity) when the intensity of the luminescence peak of magnesium oxide coarse particles 94 is assumed as 100%. The sample having the largest relative peak intensity is Sample No. 11. The relative peak intensity of Sample No. 11 reaches 99.4%. The sample having the smallest relative peak intensity is Sample No. 10.

The relative peak intensity of Sample No. 10 is 60.6%. The reason why the relative peak intensity decreases is considered that the outermost surfaces of magnesium oxide crystal particles 96 receive damages by a physical impact caused during grinding. Accordingly, it is preferable that the grinding is performed while the damage is kept minimal. Specifically, it is possible to suppress the decrease in the relative peak intensity by suppressing the energy given to magnesium oxide crystal particles 96 during the grinding. Therefore, it is preferable to setup the grinding conditions by considering the takt time or the like when the product is actually produced.

The fact that the luminescence peak is in the wavelength range between 200 nm and 300 nm means that magnesium oxide coarse particles and magnesium oxide crystal particles 96 have energy levels corresponding to the luminescence peak in the wavelength range between 200 nm and 300 nm. Electrons generated during the initializing discharge can be trapped for a long period of time (several milliseconds or longer) with the energy level. When the address voltage is applied during the address discharge, an electric field is formed in protective layer 9. Then, the trapped electrons are released into the discharge space by the heat and electric field. The discharge start time can be advanced if the initial electrons required for the start of the address discharge can be quickly and sufficiently obtained.

As described above, if the luminescence peak intensity in the wavelength range between 200 nm and 300 nm is large, it is considered that the delay in discharge can be shortened. To state it differently, suppressing the decrease in the luminescence peak intensity in the wavelength range between 200 nm and 300 nm, which is caused by grinding magnesium oxide coarse particles 94, leads to shortening the delay in discharge. [3-4. Formation method of protective layer 9]

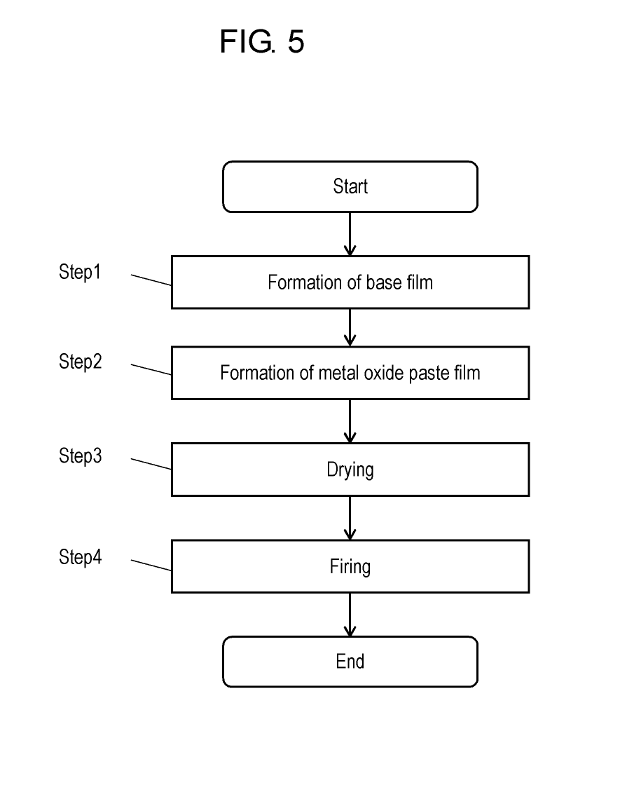

As indicated in FIG. 5, formation of protective layer 9 starts after dielectric layer 8 is formed. First, base film 91 is formed in Step 1. As its material, a sintered body of a magnesium oxide (MgO) containing aluminum (Al) is used. As its method, for example, a vacuum deposition method is used. Specifically, the raw material is irradiated with an electron beam in a vacuum chamber so that the raw material is evaporated and adhered onto dielectric layer 8. Base film 91 mainly composed of a magnesium oxide (M_{g}O) is formed on dielectric layer 8. A film thickness of base film 91 is, for example, about 500 nm to 1000 nm.

In Step 2, a metal oxide paste film is formed. A metal oxide paste resulted from mixing and kneading aggregated particles 92, an organic resin component, and a diluting solvent together is used as the material. For example, the screen printing is used as the method for forming the metal oxide paste film. Specifically, the metal oxide paste is coated on an entire surface of base film 91 to thereby form the metal oxide paste film. A thickness of the metal oxide paste film is, for example, about 5 μm to 20 μm. It is also possible to use a spraying method, the spin coating method, the die coating method, the slit coating method, or the like other than the screen printing method as a method for forming the metal oxide paste film on the base film.

In Step 3, the metal oxide paste film is dried. The metal oxide paste film is heated at a predetermined temperature in a baking oven or the like. The temperature range is, for example, about 100° C. to 150° C. The solvent component is removed from the metal oxide paste film by heating.

In Step 4, the metal oxide paste film that has been subjected to drying is fired. The metal oxide paste film is heated at a predetermined temperature in a baking oven or the like. The temperature range is, for example, about 400° C. to 500° C. The atmosphere during the firing is not particularly limited. As an example, air, oxygen, nitrogen, or the like is used. The resin component is removed from the metal oxide paste film by heating.

Through the above-mentioned process, aggregated particles 92 are adhered onto base film 91 discretely.

[4. Exemplary Embodiment]

PDP 1 is produced, and performance of PDP 1 is evaluated. PDP 1 thus produced is compatible with a high definition television set of a 42-inch class. PDP 1 is provided with front plate 2 and rear plate 10 that is arranged in a manner opposed to front plate 2. Further, peripheries of front plate 2 and rear plate 10 are sealed by the sealing portion. Front plate 2 includes display electrodes 6, dielectric layer 8, and protective layer 9. Rear plate 10 includes address electrode 12, base dielectric layer 13, barrier ribs 14, and phosphor layers 15. A neon (Ne)-xenon (Xe) mixture gas containing 15 volume percent of xenon (Xe) is sealed inside PDP 1 at an internal pressure of 60 kPa. Further, an electrode distance between display electrode 6 and display electrode 6 is 0.06 mm. A height of barrier rib 14 is 0.15 mm, and a gap (cell pitch) between barrier rib 14 and barrier rib 14 is 0.15 mm.

Aggregated particles 92 are provided in protective layer 9 of the exemplary embodiment. Magnesium oxide aggregated particles 97 listed in TABLE 1 are used as aggregated particles 92. For example, the particle size distribution of magnesium oxide aggregated particles 97 which are aggregated particles 92 of Sample No. 1 shows 0.49 μm (D10), 1.15 μm (D50), and 2.41 μm (D90). In addition, the particle size distribution of magnesium oxide coarse particles 94 shows 0.62 μm (D10), 1.86 μm (D50), and 3.71 μm (D90).

Aggregated particles 92 are provided in protective layer 9 of the comparative example. Magnesium oxide aggregated particles 97 resulted from grinding magnesium oxide coarse particles 94 by a jet mill are used as aggregated particles 92. A relative luminescence peak intensity of magnesium oxide aggregated particles 97 which are aggregated particles 92 resulted from grinding by the jet mill is 20.3% to 57.0%. The particle size distribution of the sample having a relative luminescence peak intensity of 57.0% shows 0.41 μm (D10), 1.20 μm (D50), and 2.35 μm (D90). Aggregated particles 92 of the exemplary embodiment and the comparative example have a mean particle size of 1.1 μm. A coverage factors of aggregated particles 92 of the exemplary embodiment and the comparative example are 8.0%. The coverage factor represents, in a single discharge cell, a ratio of area a in which aggregated particles 92 are adhered to area b of the single discharge cell. Specifically, it is expressed by the following expression. The coverage factor (%)=a/b×100. The measurement method thereof includes, for example, taking an image of a region corresponding to a single cell that is partitioned by barrier ribs 14. Next, the image thus taken is trimmed into a size of a single cell of x by y. Then, the image subjected to the trimming is binarized into black and white data. Subsequently, area a of a black area by aggregated particles 92 is obtained based on the binarized data. Finally, the coverage factor is calculated using the equation of a/b×100.

The difference in the manufacturing method of PDP 1 between the exemplary embodiment and the comparative example lies only in the grinding method of magnesium oxide coarse particles 94.

[4-1. Performance Evaluation]

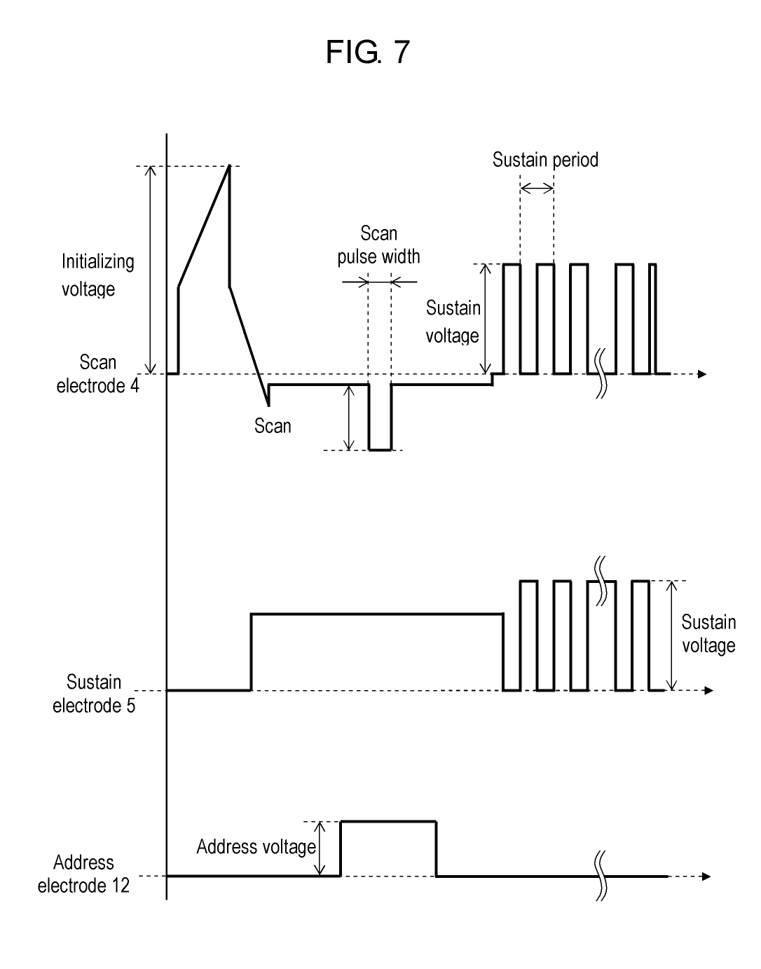

The performance of PDP 1 is evaluated by measuring a scan pulse width (application period) with which flickers due to “the delay in discharge” during address discharge is caused. As illustrated in FIG. 7, drive voltages of PDP 1 are applied to scan electrode 4, sustain electrode 5, and address electrode 12. Only the scan pulse width serves as a parameter and is varied from 1. 5 μs to 0.3 μs at an interval of 0.1 μs.

When the scan pulse width is sufficiently large, an amount of wall charges that are capable of generating sustain discharge between scan electrode 4 and sustain electrode 5 can be stored on base film 91 even if the address discharge to be generated between scan electrode 4 and address electrode 12 is delayed. However, if the scan pulse width is reduced, the scan pulse falls during the address discharge, which makes the wall charges to be stored on base film 91 insufficient. In a discharge cell with insufficient wall charges stored, even if the sustain pulse is applied, the flickers are caused because the wall charges that are sufficient to generate the stable sustain discharge are not stored.

Accordingly, as an evaluation of illumination performance of PDP 1, it is possible to evaluate the characteristic of “the delay in discharge” of PDP 1 by sequentially shortening the scan pulse width when it is normally illuminated and obtaining the scan pulse width when the flicker starts to be caused. Here, the presence or absence of the flicker is visually determined while all discharge cells of PDP 1 are illuminated (white display).

The voltage conditions applied to the PDP in this performance evaluation test are as follows.

Initializing voltage (fixed): 330V

Scan voltage (fixed): −140V, a pulse width (variable) of 0.3 μs to 1.5 μs

Address voltage (fixed): 70V

Sustain voltage (fixed): 200V and a sustain period of 0.5 μs

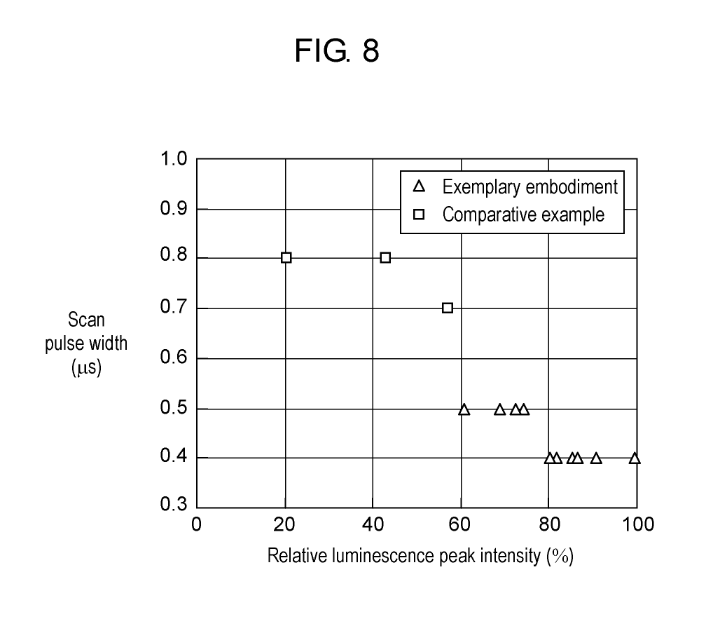

FIG. 8 indicates the relative luminescence peak intensity, and the scan pulse width when the flicker starts to be caused. Referring to FIG. 8, it is understood that the scan pulse width when the flicker starts to be caused depends on the relative luminescence peak intensity. In the case where the relative luminescence peak intensity is equal to 60% or larger and less than 100%, the flicker is not caused while the scan pulse width is 0.6 μs, and therefore this situation is preferable. This is because the period of “the delay in discharge” is shortened since aggregated particles 92 release a sufficient amount of initial electrons during the application of the scan pulse. Further, in the case where the relative luminescence peak intensity is equal to 80% or larger and less than 100%, the flicker is not caused even if the scan pulse width is 0.5 μs, and therefore this situation is further preferable. Since it is considered that the surfaces of magnesium oxide crystal particles 96 are damaged by the grinding, the relative luminescence peak intensity never becomes 100% or more by simply grinding magnesium oxide coarse particles 94.

In contrast, in the comparative example, the flicker starts to be caused with the pulse width of 0.7 μs to 0.8 μs. Since a period assigned to one field is fixed, if the application period of the scan pulse is increased, it is inevitably necessary to take measures by reducing the application period of the sustain pulse or reducing the number of subfields. According to the former measures, brightness of PDP 1 is reduced, and according to the latter measures, the number of halftones that can be expressed is reduced. Either way, deterioration in the display quality of PDP 1 is caused. Based on this result, according to PDP 1 of this exemplary embodiment, it is expected to reduce “the delay in discharge” during the address discharge and improve the display quality.

[5. Summary]

PDP 1 according to this exemplary embodiment is provided with front plate 2 and rear plate 10 disposed to oppose thereto. Front plate 2 includes display electrode 6, dielectric layer 8 covering display electrode 6, and protective layer 9 covering dielectric layer 8. Protective layer 9 includes base film 91 which is a base layer and aggregated particles 92 which are metal oxides formed on base film 91. Aggregated particles 92 are resulted from grinding magnesium oxide coarse particles 94 which are metal oxide coarse particles. Aggregated particles 92 and magnesium oxide coarse particles 94 have peaks of photoluminescence in a wavelength range between 200 nm and 300 nm. The peak of aggregated particles 92 is an intensity that is 60% or more and less than 100% of that of magnesium oxide coarse particles 94.

According to this structure, a decrease of the peak intensity of the photoluminescence in the wavelength range between 200 nm and 300 nm having high correlation with initial electron emission performance in the metal oxide can be suppressed.

It is further preferable that the peak of the metal oxide be 80% or more and less than 100% of that of the metal oxide coarse particles. According to this structure, a decrease of the peak intensity of the photoluminescence in the wavelength range between 200 nm and 300 nm having high correlation with initial electron emission performance in the metal oxide can be further suppressed.

This exemplary embodiment exemplifies the case where metal oxide crystal particles 92a are the magnesium oxide crystal particles. However, the present invention is not limited to this example. It is also possible to use strontium oxide (SrO), calcium oxide (CaO), barium oxide (BaO), aluminum oxide (Al₂O₃), or the like other than the magnesium oxide (MgO). In short, when metal oxide crystal particles 92a having high performance in releasing the initial electrons are used, a similar effect can be obtained.

Accordingly, metal oxide crystal particles 92a are not restricted to the magnesium oxide (MgO). It is also possible to use a plurality of types of metal oxide crystal particles.

Further, this exemplary embodiment exemplifies the case where aggregated particles 92 are formed on base film 91. However, the present invention is not restricted to this case. To state it differently, since metal oxide crystal particles 92a are not aggregated, metal oxide crystal particles 92a may be provided on base film 91 as a state of primary particles. To be specific, primary particles 98 of magnesium oxide crystals may be provided on base film 91.

This exemplary embodiment exemplifies the case where the base layer is a magnesium oxide film including the aluminum oxide. However, the present invention is not limited to this example. It is also possible to use a metal oxide film such as strontium oxide (SrO), calcium oxide (CaO), barium oxide (BaO), or aluminum oxide (Al₂O₃) other than the magnesium oxide (MgO). It is also possible to use a film in which a plurality of types of metal oxides are mixed.

Further, it is also possible to use an aggregate of metal oxide particles such as magnesium oxide (MgO), strontium oxide (SrO), calcium oxide (CaO), barium oxide (BaO), or aluminum oxide (Al₂O₃) other than the metal oxide film. It is also possible to use an aggregate in which a plurality of types of metal oxide particles are mixed.

### INDUSTRIAL APPLICABILITY

The technology disclosed herein is to realize a PDP that can reduce erroneous address discharge and is effective for a display device or the like having a large display screen.

### REFERENCE MARKS IN THE DRAWINGS

1: PDP

2: Front plate

3: Front glass substrate

4: Scan electrode

4a, 5a: Black electrode

4b, 5b: White electrode

5: Sustain electrode

6: Display electrode

7: Black stripe

8: Dielectric layer

9: Protective layer

10: Rear plate

11: Rear glass substrate

12: Address electrode

13: Base dielectric layer

14: Barrier rib

15: Phosphor layer

16: Discharge space

91: Base film

92a: Metal oxide crystal particle

92: Aggregated particle

94: Magnesium oxide coarse particle

96: Magnesium oxide crystal particle

97: Magnesium oxide aggregated particle

98: Primary particle of magnesium oxide crystal

1. A plasma display panel comprising:
a front plate; and
a rear plate disposed to oppose the front plate,
wherein the front plate includes a display electrode, a dielectric layer covering the display electrode, and a protective layer covering the dielectric layer,
the protective layer includes a base layer and a metal oxide formed on the base layer,
the metal oxide is produced by grinding a metal oxide coarse particle,
the metal oxide and the metal oxide coarse particle have peaks of photoluminescence in a wavelength range between 200 nm and 300 nm, and the peak of the metal oxide has an intensity of 60% or more and less than 100% that of the peak of the metal oxide coarse particle.

2. The plasma display panel according to claim 1,
wherein the intensity of the peak of the metal oxide is 80% or more and less than 100% that of the peak of the metal oxide coarse particle.
